(19) United States
(12) Patent Application Publication
(10) Pub. No.: US 2009/0078562 A1
(43) Pub. Date: Mar. 26, 2009

(54) METHOD OF SYSTEM MAINTENANCE PLANNING BASED ON CONTINUAL ROBOT PARAMETER MONITORING

(75) Inventors: Gary J. Johnson, Wappingers Falls, NY (US); Mark L. Reath, Red Hook, NY (US); David C. Strippe, Westford, VT (US)

Correspondence Address: SCULLY, SCOTT, MURPHY & PRESSER, P.C., 400 GARDEN CITY PLAZA, Suite 300, GARDEN CITY, NY, 11530, US

(73) Assignee: INTERNATIONAL BUSINESS MACHINES CORPORATION, Armonk, NY (US)

(21) Appl. No.: 11/858,406

(22) Filed: Sep. 20, 2007

(51) Int. Cl. G05B 19/19

(52) U.S. Cl. 204/192.1; 134/18; 204/298.03; 204/298.25; 204/298.32; 700/51; 901/50

(57) ABSTRACT

At least one substrate location sensor is provided on a piece of equipment containing two adjoined chambers between which substrates may be transferred one at a time. Deviation of substrate position from a predetermined optimal position is measured as a substrate is transferred between the two adjoined chambers. Measured data on the deviation of substrate position is entered into a statistical control program hosted in a computing means. The measured data indicates the level of performance of the robot and/or the condition of alignment of components in one of the two chambers. As the statistical control generates flags based on the measured data, maintenance activities may be performed. Thus, maintenance activities may be performed on a “as-needed” basis, determined by the measurement data on performance of the equipment.

### FIELD OF THE INVENTION

The present invention generally relates to methods of managing systems with a robot, and particularly to methods of planning maintenance activities based on measured robot operation parameters.

### BACKGROUND OF THE INVENTION

A piece of equipment containing a chamber and a robot to transport a substrate into the chamber typically require maintenance activities. The chamber may be a process chamber that alters the substrate in some way. For example, the chamber may be a semiconductor processing chamber capable of performing one of semiconductor processing steps such as deposition, etching, annealing, etc. The substrate may be a semiconductor substrate such as a silicon substrate that is commercially available in 300 mm, 200 mm, 150 mm, etc. in size. The process chamber may have a lid and capable of enclosing the substrate in a sub-atmospheric environment, or may not have a lid such as an exposure station or development station of a lithography tool. Typically, another chamber, which is herein referred to as a “transfer chamber,” is attached to the process chamber, and the substrate is transferred between the process chamber and the transfer chamber.

On one hand, the robot is prone to accumulation of operational displacements after repeated operation as most other moving mechanical components. In other words, as the robot moves, for example, in rotation, extension, and contraction, the precision of location of the robot degrades since each movement of robot adds to the uncertainty of the physical location of the robot. Thus, most robots require periodic calibration to avoid accumulation of positional error, and consequent adverse impacts on the equipment, which may include a physical crash of the robot or a substrate into the body of the equipment including the process chamber and the transfer chamber.

On the other hand, the process chamber typically requires maintenance activities. Oftentimes, the nature of the processing performed in the process chamber adversely impacts repeatability of the processing. Further, many process chambers contain moving parts that may fall out of alignment after repeated usage. In some cases, the processing produces byproducts such as residual deposits in the process chamber that needs to be periodically cleaned. In some other cases, a consumable component may be used up or may run through its lifetime and needs to be replaced periodically.

While degradation of robot performance and the processing capabilities of the process chamber may sometimes be predicted to a degree, determination of the precise status of the robot performance and the processing capabilities of the process chamber is very difficult. Running the equipment until substrates are processed at an unacceptable level of process deviation or until the robot triggers a physical failure such as a crash incurs economic loss through lost revenue due to lost substrates. Performing preventive maintenance activities often to avoid such a loss in substrates incurs economic loss due to sometimes unnecessarily spent time and expenses for hardware and maintenance activities.

Determination of optimal maintenance periods is very difficult since performance of robots and process chambers may differ from equipment to equipment. Yet, performance of the robot and the process chamber may impact yield of processed substrates significantly.

Referring to FIG. 1, an exemplary prior art process chamber is shown, which is a sputtering chamber for deposition of material on a substrate 50 by a process known as physical vapor deposition (PVD). The exemplary prior art process chamber comprises a chamber enclosure 12, a sputtering target 20 containing the material to be sputtered onto the substrate 50, sputtering target support structures 22, an electrostatic chuck 30 that holds the substrate 50, an electrostatic chuck support 32, and a ring assembly 40 that surrounds the electrostatic chuck 30 and provides electric field for uniform deposition of the material off the sputtering target onto the substrate 50. The substrate 50 is placed on the electrostatic chuck 30 by a robot (not shown). The sputtering target 20 is at a positive potential and the substrate 50 is at a negative potential. During sputtering, the sputtering target 20 is an electrical cathode and the substrate 50 is an electrical anode. A cathode arcing, which is an arcing between the sputtering target 20 and the substrate 50, may occur under some adverse conditions.

Accuracy of the placement of the substrate 50 on the electrostatic chuck 30 is critical in avoiding an undesirable non-cathode arcing and mechanical damage through the robot. Referring to FIG. 2, an example of the non-cathode arcing 99 is shown. The non-cathode arcing 99 refers to arcing events that does not involve the cathode, i.e., the sputtering target 20. When a substrate 50 is placed off-center on the electrostatic chuck 30, either by accumulation of positional errors in the robot or by displacements of chamber components such as the electrostatic chuck 30, the distance between an edge of the substrate 50 and the ring assembly 40 is reduced below the normal separation distance between the substrate 50 and the ring assembly 40. The reduced distance induces a higher electrical field between the ring assembly 40 and the substrate 50, which may be at a different electrical potential, and significantly increases the probability of a non-cathode arcing 99.

In a similar manner, any misalignment of the exemplary prior art process chamber, and especially a misalignment of the electrostatic chuck 30, increases the probability of the non-cathode arcing.

In general, both the accuracy of the robot operation and the alignment of internal components of the process chamber affect the probability for undesirable events associated with alignment of the robot and alignment of components of the process chamber.

In view of the above, there exists a need for methods of monitoring performance level of a robot and/or alignment of components of a process chamber to prevent misalignment related events.

Further, there exists a need for methods of determining optimal time to perform a maintenance activity on the robot or the process chamber based on the performance level of the robot and measured data on misalignment of chamber components.

### SUMMARY OF THE INVENTION

The present invention addresses the needs described above by providing methods of determining an optimal time for performing a maintenance activity based on measured data on performance of a robot or effects misalignment of components of a process chamber.

In the present invention, at least one substrate location sensor is provided on a piece of equipment containing two adjoined chambers between which substrates may be transferred one at a time. Deviation of substrate position from a predetermined optimal position is measured as a substrate is transferred between the two adjoined chambers. Measured data on the deviation of substrate position is entered into a statistical control program hosted in a computing means. The measured data indicates the level of performance of the robot and/or the condition of alignment of components in one of the two chambers. As the statistical control generates flags based on the measured data, maintenance activities may be performed. Thus, maintenance activities may be performed on a “as-needed” basis, determined by the measurement data on performance of the equipment.

According to the present invention, a method of operating a piece of equipment is provided. The piece of equipment comprises:

a first chamber;

a second chamber adjoined to the first chamber;

a robot for transferring substrates between the second chamber and the first chamber; and

at least one substrate location sensor located on the second chamber.

The method comprises:

measuring deviation of substrate position from a predetermined optimal position during transfer of the substrates between the first chamber and the second chamber;

entering measured data on the deviation of substrate position into a statistical control program; and

performing at least one maintenance activity upon flagging of the statistical control program.

In one embodiment, the first chamber accommodates only one of the substrates at a time.

In another embodiment, the first chamber is a process chamber and the second chamber is a transfer chamber, wherein the process chamber performs an alteration of the substrate.

In even another embodiment, the alteration of the substrate is one of deposition of material, etching of material from the substrate, diffusion of material within the substrate, reflow of material within the substrate, anneal of the substrate, exposure to electromagnetic radiation or energetic particles, removal of foreign material from surfaces of the substrate.

In yet another embodiment, the alteration of the substrate is deposition of material by sputtering a material off a sputtering target located in the first chamber onto the substrate.

In still another embodiment, the first chamber comprises an electrostatic chuck for placing the substrate, and wherein placement of the substrate within the first chamber affects probability of arcing within the first chamber.

In a still yet another embodiment, the first chamber and the second chamber are at sub-atmospheric pressures.

In a further embodiment, the substrate is a semiconductor substrate.

In an even further embodiment, the at least one substrate location sensor comprises a beam emitter and a beam sensor that senses a beam emitted by the beam emitter.

In a yet further embodiment, the piece of equipment further comprises a computing means for processing the measured data and running the statistical control program.

In a still further embodiment, the robot transfers only one of the substrates between the first chamber and the second chamber at a time.

In a still yet further embodiment, the measuring of the deviation of substrate position is performed during transfer of the substrates into the first chamber continually or periodically.

In further another embodiment, the at least one maintenance activity is performed on the robot.

In even further another embodiment, the measuring of the deviation of substrate position is performed during transfer of the substrates out of the first chamber continually or periodically.

In yet further another embodiment, the at least one maintenance activity is performed on the first chamber.

In still further another embodiment, the measuring of the deviation of substrate position is continually performed during transfer of the substrates into the first chamber and during transfer of the substrates out of the first chamber continually or periodically.

In still yet further another embodiment, the method comprises determining whether the flagging is caused by a subset of the measured data generated during transfer of the substrate into the first chamber or by another subset of the measured data generated during transfer of the substrate out of the first chamber.

The method may further comprise selecting a component on which the at least one maintenance activity is to be performed based on the determining.

The flagging of the statistical control program may be based on the measured data having at least one data point of which a deviation from a set target value exceeds a maximum tolerable deviation for a single data point that is set in the statistical control program.

Alternately or concurrently, the flagging of the statistical control program may be based on the measured data having a set of data points of which an average deviation from a set target value exceeds a maximum tolerable average deviation set in the statistical control program.

According to another aspect of the present invention, a system for planning at least one maintenance activity to be performed on a piece of equipment is provided. The system comprises:

a first chamber;

a second chamber adjoined to the first chamber;

a robot for transferring substrates between the second chamber and the first chamber;

at least one substrate location sensor located on the second chamber;

a measurement means for measuring deviation of substrate position from a predetermined optimal position during transfer of the substrates between the first chamber and the second chamber; and

a computing means hosting a statistical control program into which measured data on the deviation of substrate position is entered, wherein at least one maintenance activity is performed upon flagging of the statistical control program.

In one embodiment, the first chamber is a process chamber and the second chamber is a transfer chamber, wherein the process chamber performs an alteration of the substrate.

In another embodiment, the alteration of the substrate is one of deposition of material, etching of material from the substrate, diffusion of material within the substrate, reflow of material within the substrate, anneal of the substrate, exposure to electromagnetic radiation or energetic particles, removal of foreign material from surfaces of the substrate.

In yet another embodiment, the at least one substrate location sensor comprises a beam emitter and a beam sensor that senses a beam emitted by the beam emitter.

In still another embodiment, the measuring of the deviation of substrate position is continually performed during transfer of the substrates into the first chamber, during transfer of the substrates out of the first chamber, or during transfer of the substrates into the first chamber and during transfer of the substrates out of the first chamber.

### BRIEF DESCRIPTION OF THE DRAWINGS

FIG. 1 is a vertical cross-sectional view of an exemplary prior art process chamber containing a well-aligned substrate.

FIG. 2 is a vertical cross-sectional view of the exemplary prior art process chamber containing a misaligned substrate, which triggers a non-cathode arcing.

FIG. 3 shows an exemplary piece of equipment for practicing the present invention.

FIGS. 4-6 are first through third exemplary flow charts according to the present invention.

### DETAILED DESCRIPTION OF THE INVENTION

As stated above, the present invention relates to methods of managing systems with a robot, and particularly to methods of planning maintenance activities based on measured robot operation parameters, which are now described in detail with accompanying figures. It is noted that like and corresponding elements are referred to by like reference numerals.

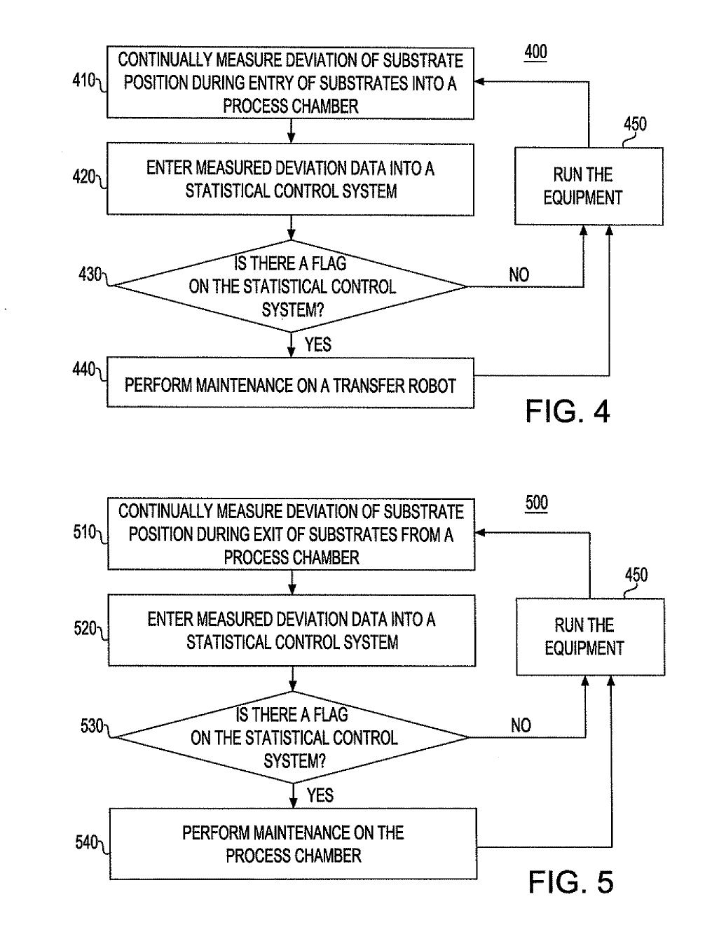

Referring to FIG. 3, an exemplary piece of equipment for practicing the present invention is shown in a see-through top-down view in which lids of various chambers are not shown for clarity. The exemplary piece of equipment comprises a transfer chamber 60 that hosts a robot comprising a robot pivot axis 72, robot upper arms 74, robot elbow pins 75, robot lower arms 76, and a robot blade 78. The robot may carry a substrate 50 on the robot blade 78 and move the substrate 50 by rotation, extension, and/or contraction of the various components of the robot. The components and assembly of the robot may vary in various embodiments provided that the robot transfers the substrate to and from the transfer chamber 60 to a process chamber 10.

Robots carrying multiple substrates 50 at a time, for example, by vertically stacking multiple robot blades, are known in the art. While the present invention is described with a robot carrying a single substrate 50 at a time, embodiments of the present invention in which the robot carries multiple substrates 50 are explicitly contemplated herein.

The substrate 50 may comprise any solid piece that may be altered by processing in a chamber. The substrate 50 may comprise a metal, a semiconductor material, an insulator material, or a combination thereof. The substrate 50 has a predefined shape so that different substrates 50 occupy approximately the same area on the robot blade 78 upon loading onto the robot blade. For purposes of description of the present invention, the substrate 50 is a semiconductor substrate such as a commercially available 300 mm silicon substrate.

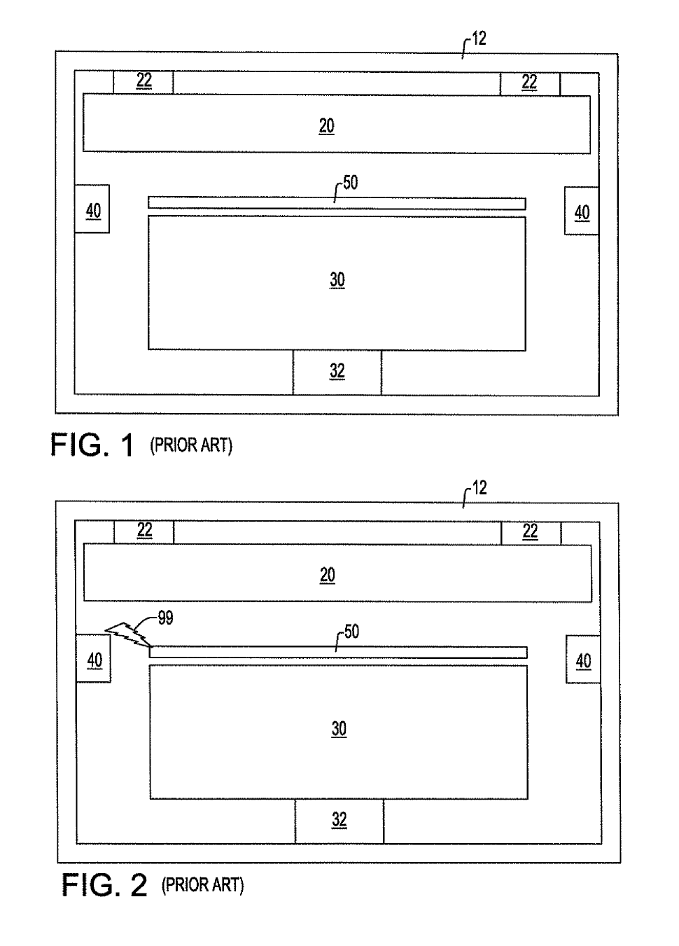

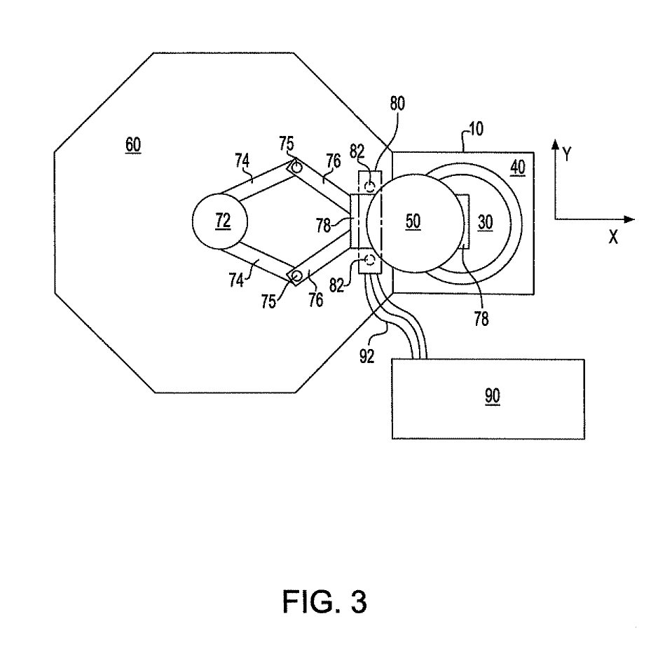

The process chamber 10 may be a sputtering chamber as shown in FIGS. 1 and 2. In this case, the process chamber comprises an electrostatic chuck 30 and a ring assembly 40. The direction of movement of the substrate 50 during transfer of the substrate 50 between the transfer chamber 60 and the process chamber 10 is herein referred to as an X-direction. The direction perpendicular to the X-direction within the plane of FIG. 3 is herein referred to as a Y-direction.

When the electric field associated with this charge accumulation exceeds the breakdown potential of the gas in the sputtering chamber, a non-cathode arc discharge, or a “non-cathode arcing” occurs. This is an arcing that does not involve the sputtering target 20, and is caused by accumulation of charge on other components within the sputtering chamber 20. Robot placement errors and offsets can result in the wafer being placed nearer to a charge-prone region of the reactor, and increase the probability that the wafer will be damaged. The resulting wafer damage may appear to be random, but the robot data can help pinpoint the problem.

The transfer chamber 60 and the process chamber 10 may be operated at the atmospheric pressure, at sub-atmospheric pressures, in high vacuum, or in pressurized conditions. The transfer chamber 60 and the process chamber may operate at the same pressure, or a pressure differential between chambers may be maintained to prevent outdiffusion of gases or particles from one chamber into another.

The process chamber may accommodate only one substrate 50 at a time as many of commercially available “single wafer” semiconductor processing chambers do, or may allow loading of multiple substrates 50 at a time as some “batch” semiconductor processing chambers do, e.g., a boat of a furnace. For the purpose of description of the present invention, a single wafer semiconductor processing chamber is employed for the process chamber 10. However embodiments in which multiple substrates 50 are accommodated into the process chamber 10 are explicitly contemplate herein.

In general, the process chamber 10 processes the substrate, i.e., alters the substrate 10 in some way. Typical processing in the process chamber 10 may be one of deposition of material, etching of material from the substrate, diffusion of material within the substrate, reflow of material within the substrate, anneal of the substrate, exposure to electromagnetic radiation or energetic particles, removal of foreign material from surfaces of the substrate. In case the substrate 10 is a semiconductor substrate, semiconductor processing known in the art may be practiced. The materials that may be deposited or etched in the process chamber 10 include a metal, a semiconductor material, and an insulator material. Electrical dopants may be activated or diffused by a thermal cycling at an elevated temperature. A photoresist may be applied or developed by ultraviolet light. Electrical dopants may be implanted into the substrate 50. Foreign material may be removed from the surface of the substrate by a cryogenic clean in which high energy atoms impinge on the substrate 10 at a glancing angle to transfer momentum to any foreign material on the surface of the substrate 10. In some other cases, the process chamber may orientate the substrate, for example, by finding a notch or a substrate flat and azimuthally aligning the substrate 10.

In case the process chamber 10 is a sputtering chamber, material of a sputtering target 20 (See FIGS. 1 and 2) may be sputtered off the sputtering target 20 onto the substrate 50 within the process chamber 10. As described above, the placement of the substrate 50 within the process chamber 10 affects probability of arcing within the process chamber 10. The placement of the substrate 50 on the electrostatic chuck 30 is affected by the accuracy of the movement of the robot as well as alignment of the components within the process chamber 10. For example, the robot may not place the substrate 10 at an optimal position due to accumulation of positional errors after a large number of movements. Changes in azimuthal alignment of the robot pivot axis results in changes in placement of the substrate 50 within the process chamber 10 in the Y-direction. Changes in the amount of extension of the robot blade 78 results in changes in placement of the substrate within the process chamber 10 in the X-direction. Further, the electrostatic chuck 30 or components thereof may move from the original position after repeated operations. Such a movement may cause additional movement of the substrate 50 after placement of the substrate 50 on the electrostatic chuck 30 in the X-direction or in the Y-direction.

As shown in FIG. 3, at least one substrate location sensor 80 is provided across the path of the substrate 50 between the transfer chamber 60 and the process chamber 10. The at least one substrate location sensor 80 is represented by a dotted rectangle. Physical components of the at least one substrate location sensor 80 are not in the plane of the substrate 50, i.e., located above and/or below the substrate 50. The at least one substrate location sensor 80 is mounted on the frame of the transfer chamber 60 or on the frame of the process chamber. Components of the at least one substrate location sensor 80 may be located inside the transfer chamber 60, inside the process chamber 10, outside the transfer chamber 60 on a window (not shown) formed in the lid or the bottom surface of the transfer chamber 60, and/or outside the process chamber 10 on a window (not shown) formed on the enclosure of the process chamber 10. Preferably, the components of the at least one substrate location sensor 80 are mounted inside the transfer chamber 60 or on the outside of the transfer chamber 60 on the window.

Each of the at least one substrate location sensor 80 may comprise a beam emitter located on one side of a path of the substrate 50 and a beam sensor located on an opposite side of the path of the substrate 50 so that in the absence of intervening structure therebetween, the beam sensor detects a beam 82, schematically shown by a dotted circle, that is emitted from the beam emitter. Alternately, the at least one substrate location sensor 80 may comprise a beam emitter and a beam sensor located on the same side of the path of the substrate 50 so that the beam sensor detects the beam 82 only while the substrate 50 reflects the beam during transit from or to the process chamber 10. The beam 82 may be an infrared beam, an optical beam, or an ultraviolet beam. Typically, the diameter or a characteristic dimension of the beam may be from 0.5 mm to about 5 mm. Typically, multiple pairs of beam emitters and beam sensors are employed.

The at least one substrate location sensor 80 detects the position of the substrate 50 during the transit from the transfer chamber 60 to the process chamber 10 and/or during the transit from the process chamber 10 to the transfer chamber 60. The duration of detection, or disruption of detection, of the optical beams by the beam sensors may be compared to determine the position of the substrate 50 in the Y-direction relative to the frame to which the at least one substrate location sensor 80 is attached, e.g., the transfer chamber 60. For example, if the azimuthal rotation of the robot around the robot pivot axis 72 drifts and the robot moves counterclockwise, the duration of signal on a beam sensor located above an upper portion of the substrate 50 increases, while the duration of signal on another beam sensor located above a lower portion of the substrate 50 decreases.

Further, by comparing timing data between extension of the robot blade 78 and the signals from the beam sensors, the position of the substrate 50 in the X-direction relative to the frame to which the at least one substrate location sensor 80 is attached, e.g., the transfer chamber 60. For example, if the robot blade 78 is not extending as much as it is supposed to, at the time when trailing edges of the substrate 50 is expected during a transfer of the substrate 50 into the process chamber 10, i.e., at the time when the signal for presence of the substrate is expected to discontinue, the trailing edges are not detected since portions of the substrate 50 is still within the area of the beams. Thus, any deviation of the position of the substrate 50 from a predetermined optimal position due to inaccuracy of the robot, irrespective of the origin of the inaccuracy, may be detected by the at least one substrate location sensor.

In the same way, any deviation in the position of the substrate 50 from a predetermined optimal position during transfer of the substrate 50 from the process chamber 10 into the transfer chamber 60 may be detected. The deviation measured as the substrate exits the process chamber is a convolution of the deviation in the position of the substrate 50 that is present at the time the substrate is transferred into the process chamber 10 and additional deviation in the position due to a movement of the substrate 50 within the process chamber. The two components of the deviation measured during the transfer of the substrate 50 from the process chamber 10 into the transfer chamber 10 may be deconvoluted to calculate the contribution of the process chamber 10 in the measured deviation. The amount of deviation caused by the process chamber 10 may be correlated to performance or condition of the process chamber 10 to infer whether there is a need to perform a maintenance activity on the process chamber 10.

As further shown in FIG. 3, the output signal of each of the beam sensors is routed from the at least one substrate location sensor 80 to a computing means 90 via a set of signal transmission cables 92. The computing means contains a calculation means for extracting deviation of the position of the substrate 50 from the predetermined optimal position from the signals generated by the beam sensors. The computing means may include an equipment controller, a dedicated computer, or a combination of the two. Further, the computing means hosts a statistical control program into which the extracted data on the deviation of the position of the substrate 50 is entered. The statistical control program analyzes the data on the deviation of the substrate position according to a predetermined algorithm to generate flags when the pattern in the dataset meets predetermined criteria. Upon flagging of the statistical control program, at least one maintenance activity may be performed on the robot, the process chamber, or both.

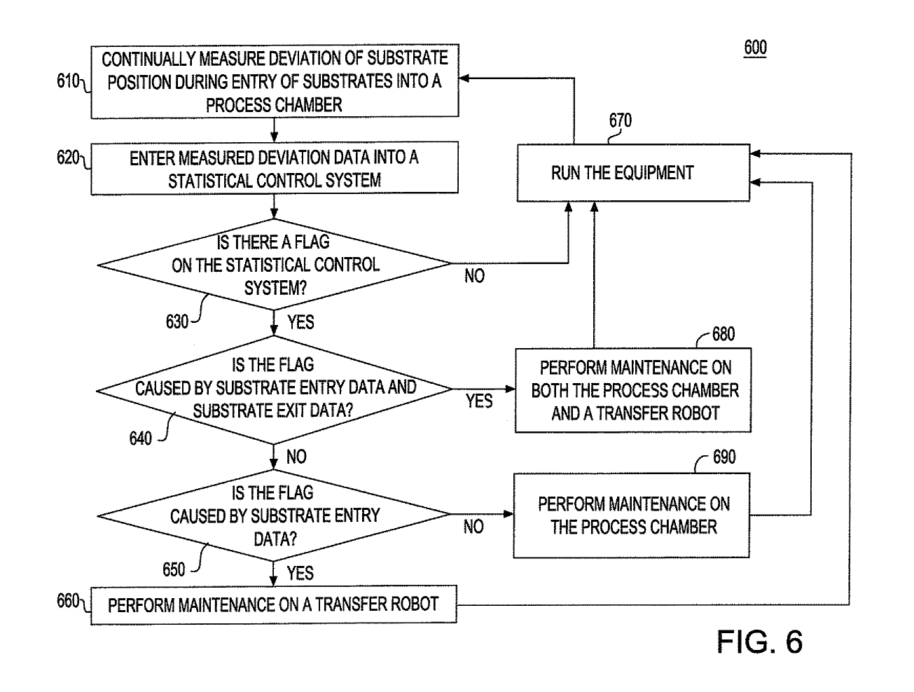

Referring to FIG. 4, a first flow chart 400 for planning maintenance activities on a piece of equipment according to a first embodiment of the present invention is shown. In a first step 410, the deviation of the substrate position is continually measured by the at least one substrate location sensor 80 during each successive entry of a substrate 50 into the process chamber 10, i.e., during transfer of the substrates 50 from the transfer chamber 60 into the process chamber 10. Multiple substrates 50 may be transferred at a time, or more preferably, one substrate 50 is transferred at a time. The continual measurement may be performed on every substrate 50 that enters the process chamber 10, or some of the substrates 50 may be sampled at a predetermined interval, e.g., every second substrate 50, every third substrate 50, etc. Preferably, the continual measurement of the deviation of the substrate location is performed on every substrate 50.

In a second step 420, the measured deviation data is entered into a statistical control system hosted by the computing means described above. The statistical control system runs an algorithm that generates a flag when the set of recent data satisfies one of predefined criteria. The criteria may be based on one or multiple data points. For example, the flagging of the statistical control program may be based on the measured data having at least one data point of which a deviation from a set target value exceeds a maximum tolerable deviation for a single data point that is set in the statistical control program. Alternately or concurrently, the flagging of the statistical control program may be based on the measured data having a set of data points of which an average deviation from a set target value exceeds a maximum tolerable average deviation set in the statistical control program.

The deviation in the X-direction (See FIG. 3) and the deviation in the Y-direction (See FIG. 3) may be tracked separately or in combination as an absolute magnitude of vector variation. The deviation from the set target value may, or may not, be a linear deviation from the set target. In other words, the deviation 6 for a single data point may have the mathematical form σ=|d−t|^{γ}, in which d is a component of the measured values of the data point for the substrate location, t is a predefined optimal value for the component of the data point for the substrate location, and γ is an exponent having a positive value. The average deviation σ̅ may be defined employing one of many methods of deriving an average. For example, the average deviation σ̅ may have the mathematical form

$$\overline{σ} = \{ {\sum }_{i = 1}^{N} {\vert {d}_{i} - t \vert}^{γ} \} / N ,$$

in which the dᵢ is a component of an i-th measured value of the data point for the substrate location, t is a predefined optimal value for the component of the data point for the substrate location, and γ is an exponent having a positive value, and N is the number of samples used in the calculation of the average deviation σ̅. Alternate methods of calculating the average deviation σ̅, such as

$$\overline{σ} = {\{ {\prod }_{i = 1}^{N} {\vert {d}_{i} - t \vert}^{γ} \}}^{1 / N} ,$$

may be employed as well.

The flag may indicate potential problem with the robot at multiple levels, such as an “attention” level, a “warning” level, and an “inhibit” level. The flag may be displayed in a tabular format or in a graphic format, and may display only a relevant data set that contributed to the generation of the flag, or may include data including recent trends within a certain time interval or a fixed number of recent data points. The flag may be forwarded to a controller of the piece of equipment so that an operator is required to review the flag before running the piece of equipment. The flag may also be forwarded to personnel in charge of maintenance of the equipment as a message embedded in an electronic mail for review.

In a third step 430, presence or absence of a flag on the statistical control system is examined. If no flag is present on the statistical control system, the piece of equipment may be run according to the fifth step 450 of the first flow chart 400. As the piece of equipment continues to operate, data on deviation of the substrate position is taken on the next substrate 50, and the algorithm in the first flow chart 400 continues.

If a flag is present on the statistical control system at the third step 430, at least one maintenance activity is performed on the robot as indicated at step 440. There may be multiple levels of maintenance activities such as testing of the robot, recalibration of the robot, reassembly of the robot, and/or recalibration of the robot relative to the process chamber 10.

Referring to FIG. 5, a second flow chart 500 for planning maintenance activities on a piece of equipment according to a second embodiment of the present invention is shown. In a first step 510, the deviation of the substrate position is continually measured by the at least one substrate location sensor 80 during each successive exit of a substrate 50 out of the process chamber 10, i.e., during transfer of the substrates 50 from the process chamber 10 into the transfer chamber 60. Multiple substrates 50 may be transferred at a time, or more preferably, one substrate 50 is transferred at a time. The continual measurement may be performed on every substrate 50 that exits the process chamber 10, or some of the substrates 50 may be sampled at a predetermined interval, e.g., every second substrate 50, every third substrate 50, etc. Preferably, the continual measurement of the deviation of the substrate location is performed on every substrate 50. Measurement methods described above may be employed.

In a second step 520, the measured deviation data is entered into a statistical control system hosted by the computing means described above. The statistical control system runs an algorithm that generates a flag when the set of recent data satisfies one of predefined criteria as in the first embodiment. The flag may indicate potential problem with the process chamber 10 at multiple levels, such as an “attention” level, a “warning” level, and an “inhibit” level depending on the level of severity of the potential problem. The flag may be displayed, forwarded to a controller of the piece of equipment, and/or forwarded to personnel in charge of maintenance of the equipment as in the first embodiment.

In a third step 530, presence or absence of a flag on the statistical control system is examined. If no flag is present on the statistical control system, the piece of equipment may be run according to the fifth step 550 of the second flow chart 500. As the piece of equipment continues to operate, data on deviation of the substrate position is taken on the next substrate 50, and the algorithm in the second flow chart 500 continues.

If a flag is present on the statistical control system at the third step 530, at least one maintenance activity is performed on the process chamber 10 as indicated at step 540. There may be multiple levels of maintenance activities such as testing of moving parts of the process chamber 10, recalibration of the moving parts, reassembly of the process chamber 10, and/or recalibration of the process chamber 10 relative to the robot.

Referring to FIG. 6, a third flow chart 600 for planning maintenance activities on a piece of equipment according to a third embodiment of the present invention is shown. In a first step 610, the deviation of the substrate position is continually measured by the at least one substrate location sensor 80 during successive entry of substrates 50 into the process chamber 10 and during successive exit of substrates 50 out of the process chamber 10. Multiple substrates 50 may be transferred at a time, or more preferably, one substrate 50 is transferred at a time. The continual measurement may be performed on every substrate 50 that enters and exits the process chamber 10, or some of the substrates 50 may be sampled at a predetermined interval, e.g., every second substrate 50, every third substrate 50, etc. Preferably, the continual measurement of the deviation of the substrate location is performed on every substrate 50. Measurement methods described above may be employed.

In a second step 620, the measured deviation data is entered into a statistical control system hosted by the computing means described above. The statistical control system runs an algorithm that generates a flag when the set of recent data satisfies one of predefined criteria as in the first and second embodiment. The flag may indicate potential problem with the robot or the process chamber 10 at multiple levels, such as an “attention” level, a “warning” level, and an “inhibit” level. The flag may be displayed, forwarded to a controller of the piece of equipment, and/or forwarded to personnel in charge of maintenance of the equipment as in the first and second embodiments.

In a third step 630, the presence or absence of a flag on the statistical control system is examined. If no flag is present on the statistical control system, the piece of equipment may be run according to the seventh step 670 of the third flow chart 600. As the piece of equipment continues to operate, data on deviation of the substrate position is taken on the next substrate 50, and the algorithm in the second flow chart 600 continues.

If a flag is present on the statistical control system at the third step 530, the nature of the flag is examined at a fourth step 640. If both the robot and the process chamber 10 caused the flag, maintenance activities are performed on the robot and the process chamber 10 according to an eighth step 680. There may be multiple levels of maintenance activities such as testing of the robot, recalibration of the robot, reassembly of the robot, recalibration of the robot relative to the process chamber 10, testing of moving parts of the process chamber 10, recalibration of the moving parts, reassembly of the process chamber 10, and/or recalibration of the process chamber 10 relative to the robot.

Referring to a fifth step 650, if only one of the robot and the process chamber 10 caused the flag, relevant data sets are reviewed and analyzed to determined whether the flagging is caused by a subset of the measured data generated during transfer of the substrate into the process chamber 10 or by another subset of the measured data generated during transfer of the substrate out of the process chamber 10. Such determination may be made manually, or more preferably, by an automated algorithm built into the statistical control system. A component on which the at least one maintenance activity is to be performed is selected based on the results of such determination.

Specifically, if the robot is determined to be the source of deviations that resulted in generation of the flag, at least one maintenance activities is performed on the robot according to a sixth step 660. If the process chamber 10 is determined to be the source of deviations that resulted in generation of the flag, at least one maintenance activity is performed on the process chamber 10. After the at least one maintenance activity which may include testing of substrate transfer after modification of any parts, the piece of equipment may resume operation.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A method of operating a piece of equipment, said piece of equipment comprising:
a first chamber;
a second chamber adjoined to said first chamber;
a robot for transferring substrates between said second chamber and said first chamber; and
at least one substrate location sensor located on said second chamber; and said method comprising:
measuring deviation of substrate position from a predetermined optimal position during transfer of said substrates between said first chamber and said second chamber;
entering measured data on said deviation of substrate position into a statistical control program; and
performing at least one maintenance activity upon flagging of said statistical control program.

2. The method of claim 1, wherein said first chamber is a process chamber and said second chamber is a transfer chamber, wherein said process chamber performs an alteration of said substrate.

3. The method of claim 2, wherein said alteration of said substrate is one of deposition of material, etching of material from said substrate, diffusion of material within said substrate, reflow of material within said substrate, anneal of said substrate, exposure to electromagnetic radiation or energetic particles, removal of foreign material from surfaces of said substrate.

4. The method of claim 3, wherein said alteration of said substrate is deposition of material by sputtering a material off a sputtering target located in said first chamber onto said substrate.

5. The method of claim 4, wherein said first chamber comprises an electrostatic chuck for placing said substrate, and wherein placement of said substrate within said first chamber affects probability of arcing within said first chamber.

6. The method of claim 1, wherein said substrate is a semiconductor substrate and said first chamber accommodates only one of said substrates at a time.

7. The method of claim 1, wherein said at least one substrate location sensor comprises a beam emitter and a beam sensor that senses a beam emitted by said beam emitter.

8. The method of claim 1, wherein said piece of equipment further comprises a computing means for processing said measured data and running said statistical control program.

9. The method of claim 1, wherein said robot transfers only one of said substrates between said first chamber and said second chamber at a time.

10. The method of claim 1, wherein said measuring of said deviation of substrate position is performed during transfer of said substrates into said first chamber continually or periodically.

11. The method of claim 1, wherein said measuring of said deviation of substrate position is performed during transfer of said substrates out of said first chamber continually or periodically.

12. The method of claim 1, wherein said measuring of said deviation of substrate position is performed during transfer of said substrates into said first chamber and during transfer of said substrates out of said first chamber continually or periodically.

13. The method of claim 12, further comprising determining whether said flagging is caused by a subset of said measured data generated during transfer of said substrate into said first chamber or by another subset of said measured data generated during transfer of said substrate out of said first chamber.

14. The method of claim 1, wherein said flagging of said statistical control program is based on said measured data having at least one data point of which a deviation from a set target value exceeds a maximum tolerable deviation for a single data point that is set in said statistical control program.

15. The method of claim 1, wherein said flagging of said statistical control program is based on said measured data having a set of data points of which an average deviation from a set target value exceeds a maximum tolerable average deviation set in said statistical control program.

16. A system for planning at least one maintenance activity to be performed on a piece of equipment, said system comprising:
a first chamber;
a second chamber adjoined to said first chamber;
a robot for transferring substrates between said second chamber and said first chamber;
at least one substrate location sensor located on said second chamber;
a measurement means for measuring deviation of substrate position from a predetermined optimal position during transfer of said substrates between said first chamber and said second chamber; and
a computing means hosting a statistical control program into which measured data on said deviation of substrate position is entered, wherein at least one maintenance activity is performed upon flagging of said statistical control program.

17. The system of claim 16, wherein said first chamber is a process chamber and said second chamber is a transfer chamber, wherein said process chamber performs an alteration of said substrate.

18. The system of claim 17, wherein said alteration of said substrate is one of deposition of material, etching of material from said substrate, diffusion of material within said substrate, reflow of material within said substrate, anneal of said substrate, exposure to electromagnetic radiation or energetic particles, removal of foreign material from surfaces of said substrate.

19. The system of claim 16, wherein said at lease one substrate location sensor comprises a beam emitter and a beam sensor that senses a beam emitted by said beam emitter.

20. The system of claim 16, wherein said measuring of said deviation of substrate position is continually performed during transfer of said substrates into said first chamber, during transfer of said substrates out of said first chamber, or during transfer of said substrates into said first chamber and during transfer of said substrates out of said first chamber.
